(19) United States
(12) Patent Application Publication
(10) Pub. No.: US 2021/0005079 A1
(43) Pub. Date: Jan. 7, 2021

(54) UAV COMMUNICATION CONTROL METHOD AND SYSTEM, AND UAV

(71) Applicant: SZ DJI TECHNOLOGY CO., LTD., Shenzhen (CN)

(72) Inventors: Yong YANG, Shenzhen (CN); Hanping CHEN, Shenzhen (CN); Chuantang XIONG, Shenzhen (CN)

(21) Appl. No.: 17/029,884

(22) Filed: Sep. 23, 2020

Related U.S. Application Data
(63) Continuation of application No. PCT/CN2018/080160, filed on Mar. 23, 2018.

(51) Int. Cl. G08C 17/02; B64C 39/02; B64D 1/00

(52) U.S. Cl. CPC G08C 17/02; B64C 2201/027; B64D 1/00; B64C 39/024

(57) ABSTRACT

A communication control method for an unmanned aerial vehicle (UAV) includes transmitting a first information between the UAV and a payload apparatus via a first communication link and transmitting a second information between the UAV and the payload apparatus via a second communication link. Security of the first communication link is higher than security of the second communication link, and a bandwidth of the first communication link is lower than a bandwidth of the second communication link.

### CROSS-REFERENCE TO RELATED APPLICATION

This application is a continuation of International Application No. PCT/CN2018/080160, filed on Mar. 23, 2018, the entire content of which is incorporated herein by reference.

### TECHNICAL FIELD

The embodiments of the present disclosure relate to the technical field of unmanned aerial vehicle (UAV), and in particular relates to a communication control method and system for a UAV and a UAV.

### BACKGROUND

At present, a UAV can be equipped with payload apparatus manufactured by third-party manufacturers, including but not limited to: cameras, environmental detectors, lights, speakers, etc. For example, the camera can take pictures during the flight of the UAV, and the environment detector can detect the environmental parameters of the UAV's flight position. Therefore, the UAV equipped with payload apparatus can achieve multiple functions. Since the payload apparatus is mounted on the UAV, and the UAV is controlled by the remote control on the ground, the payload apparatus can communicate with the UAV to transmit data with a remote control on the ground. The payload apparatus in the existing technology is connected to the UAV via a network port, that is, all data transmitted between the payload apparatus and the remote controller is via the network port (i.e., the same communication channel). The data transmitted includes control commands, emergency alarm information of payload apparatus, sensor data of payload apparatus, etc. The control commands and emergency alarm information are relatively more important than the sensor data. If such data are all transmitted via the same communication channel at the same time, the transmission of important data such as control commands and emergency alarm information may fail.

### SUMMARY

According to one aspect of the present disclosure, there is provided a communication control method for an unmanned aerial vehicle (UAV). The method includes transmitting a first information between the UAV and a payload apparatus via a first communication link and transmitting a second information between the UAV and the payload apparatus via a second communication link. Security of the first communication link is higher than security of the second communication link, and a bandwidth of the first communication link is lower than a bandwidth of the second communication link.

According to another aspect of the present disclosure, there is further provided a UAV. The UAV includes a controller, a first communication interface, and a second communication interface. The first communication interface is configured to establish a first communication link; the second communication interface is configured to establish a second communication link; and the controller is configured to control the first communication interface to communicate a first information with a payload apparatus via the first communication link and control the second communication interface to communicate a second information with the payload apparatus via the second communication link. Security of the first communication link is higher than security of the second communication link, and a bandwidth of the first communication link is lower than a bandwidth of the second communication link.

### BRIEF DESCRIPTION OF THE DRAWINGS

In order to explain the embodiments of the present disclosure or the technical solutions in the existing technology more clearly, the following will briefly introduce the drawings that need to be used in the description of the embodiments or the existing technology. Apparently, the drawings in the following description are some of the embodiments of the present disclosure. For those of ordinary skill in the art, other drawings can be obtained from these drawings without creative effort.

FIG. 1 is a schematic structural diagram of an unmanned aerial system (UAV) according to an embodiment of the present disclosure;

FIG. 2 is a flowchart of a communication control method for a UAV according to an embodiment of the present disclosure;

FIG. 3 is a schematic diagram of an application scenario of the communication control method for a UAV according to an embodiment of the present disclosure;

FIG. 4 is a schematic diagram of the application scenario of the communication control method for a UAV according to another embodiment of the present disclosure;

FIG. 5 is a schematic structural diagram of a UAV according to an embodiment of the present disclosure; and

FIG. 6 is a schematic structural diagram of a communication control system for a UAV according an embodiment of the present disclosure.

### DETAILED DESCRIPTION OF THE EMBODIMENTS

In order to make the objectives, technical solutions, and advantages of the embodiments of the present disclosure clear, the technical solutions in the embodiments of the present disclosure will be described clearly and completely in conjunction with the accompanying drawings in the embodiments of the present disclosure. Apparently, the described embodiments are some of the embodiments of the present disclosure, but not all the embodiments. Based on the embodiments of the present disclosure, all other embodiments obtained by those of ordinary skill in the art without creative effort shall fall within the scope of the disclosure.

The embodiments of the present disclosure provide a communication control method and system for a UAV, and a UAV. The UAV involved may be a rotorcraft, for example, a multi-rotor aircraft propelled by multiple propulsion devices via the air, and the embodiments of the present disclosure are not limited thereto.

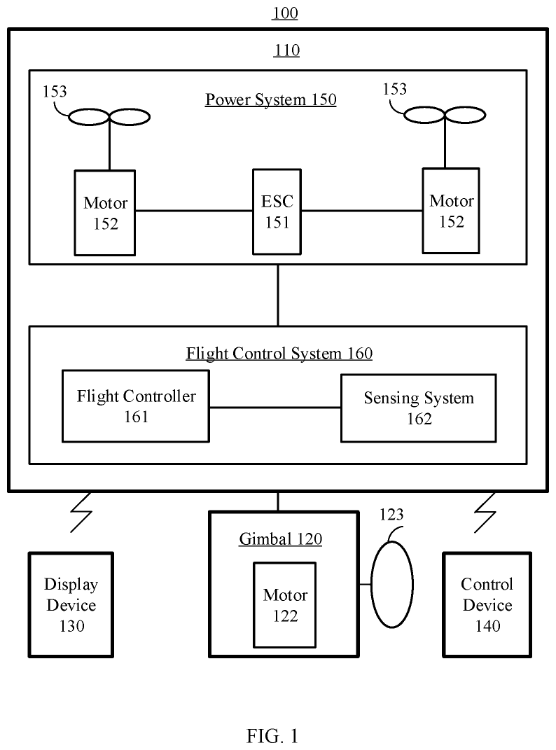

FIG. 1 is a schematic structural diagram of a UAV according to an embodiment of the present disclosure. In an exemplary embodiment, a rotary wing UAV is taken as an example for description.

A UAV system 100 may include an UAV 110, a gimbal 120, a display device 130, and a control device 140. The UAV 110 may include a propulsion system 150, a flight control system 160, and a frame. The UAV 110 can wirelessly communicate with the control device 140 and the display device 130.

The frame may include a body and a stand (also called a landing gear). The body may include a center frame and one or more arms connected to the center frame, and the one or more arms extend radially from the center frame. The stand is connected to the body and configured to support the UAV 110 during landing.

The propulsion system 150 may include one or more electronic speed controls (ESCs) 151, one or more propellers 153, and one or more motors 152 corresponding to the one or more propellers 153. The motors 152 are connected between the ESC 151 and the propeller 153, and the motor 152 and the propeller 153 are disposed on the arm of the UAV 110. The ESC 151 is configured to receive a drive signal generated by the flight control system 160 and provide drive current to the motor 152 according to the drive signal to control rotation speed of the motor 152. The motor 152 is configured to drive the propeller to rotate, thereby supplying propulsion for the flight of the UAV 110, and the propulsion enables the UAV 110 to achieve one or more degrees of freedom of movement. In some embodiments, UAV 110 may rotate about one or more rotation axes. For example, the foregoing-mentioned rotation axis may include roll axis, yaw axis, and pitch axis. It should be understood that the motor 152 may be a DC motor or an AC motor. In addition, the motor 152 may be a brushless motor or a brushed motor.

The flight control system 160 may include a flight controller 161 and a sensing system 162. The sensing system 162 is configured to measure attitude information of the UAV, that is, the position information and state information of the UAV 110 in space, such as three-dimensional position, three-dimensional angle, three-dimensional velocity, three-dimensional acceleration, and three-dimensional angular velocity. The sensing system 162 may include, for example, at least one of sensors such as a gyroscope, an ultrasonic sensor, an electronic compass, an inertial measurement unit (IMU), a vision sensor, a global navigation satellite system, and a barometer. For example, the global navigation satellite system may be a global positioning system (GPS). The flight controller 161 is configured to control the flight of the UAV 110. For example, the flight of the UAV 110 can be controlled according to the attitude information measured by the sensing system 162. It should be understood that the flight controller 161 can control the UAV 110 according to pre-programmed program commands and can also control the UAV 110 by responding to one or more control commands from the control device 140.

The gimbal 120 may include a motor 122. The gimbal is configured to carry the imaging device 123. The flight controller 161 can control movement of the gimbal 120 via the motor 122. Optionally, in another embodiment, the gimbal 120 may further include a controller for controlling the movement of the gimbal 120 by controlling the motor 122. It should be understood that the gimbal 120 may be independent of the UAV 110 or may be a part of the UAV 110. It should be understood that the motor 122 may be a DC motor or an AC motor. In addition, the motor 122 may be a brushless motor or a brushed motor. It should also be understood that the gimbal may be located on the top of the UAV or on the bottom of the UAV.

The imaging device 123 may be, for example, a device for capturing images, such as a camera or a video camera, and the imaging device 123 may communicate with the flight controller and perform image/video shooting under control of the flight controller. The imaging device 123 of this embodiment at least includes a photosensitive element. The photosensitive element may be, for example, a complementary metal oxide semiconductor (CMOS) sensor or a charge-coupled device (CCD) sensor.

The display device 130 may be located at the ground end of the UAV system 100 and communicate with the UAV 110 in a wireless manner and may be configured to display the attitude information of the UAV 110. In addition, the image captured by the imaging device may also be displayed on the display device 130. It should be understood that the display device 130 may be an independent device or integrated in the control device 140.

The control device 140 may be located at the ground end of the UAV system 100 and can communicate with the UAV 110 in a wireless manner for remote control of the UAV 110.

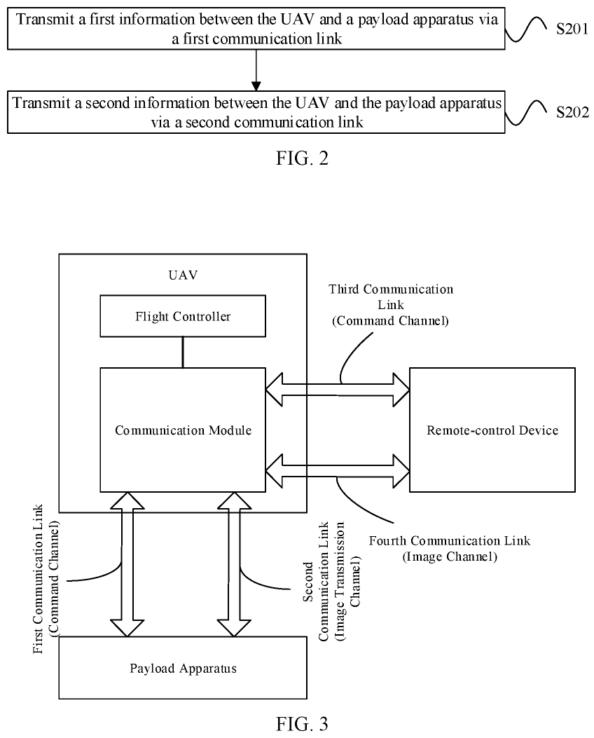

FIG. 2 is a flowchart of a communication control method for a UAV according to an embodiment of the present disclosure. As shown in FIG. 2, the method of this embodiment may include:

S201: Transmitting a first information between the UAV and a payload apparatus via a first communication link; and

S202: Transmitting a second information between the UAV and the payload apparatus via a second communication link.

In this embodiment, the first information may be transmitted between the UAV and the payload apparatus via the first communication link, and in addition, the second information may be transmitted between the UAV and the payload apparatus via the second communication link. The first communication link and the second communication link are different links, and security of the first communication link may be higher than security of the second communication link, and a bandwidth of the first communication link may be than a bandwidth of the second communication link.

Since the security of the first communication link is higher than the security the second communication link, the importance of the first information may be higher than the importance of the second information. Accordingly, the information transmitted between the UAV and the payload apparatus can be transmitted based on the different importance via different communication links (e.g., the above-mentioned first communication link or the above-mentioned second communication link). Since the bandwidth of the first communication link is smaller than the bandwidth of the second communication link, a data volume of the first information can be smaller than a data volume of the second information, so the information transmitted between the UAV and the payload apparatus can be based on the different data volumes via different communication links (e.g., the above-mentioned first communication link or the above-mentioned second communication link).

The embodiment does not limit the execution sequence between S201 and S202.

In this embodiment, the UAV communicates with the payload apparatus via two communication links. Since the security and the bandwidth of the two communication links are different, accordingly, the information matching the communication links can be communicated via different communication links. Accordingly, the UAV communicates a part of the information with the payload apparatus via the first communication link, and communicates another part of the information with the payload apparatus via the second communication link, thereby improving the success rate of the information transmission between the UAV and the payload apparatus.

In some embodiments, the aforementioned transmission of the first information between the UAV and the payload apparatus via the first communication link may include: the UAV sends the first information to the payload apparatus via the first communication link, and/or, the UAV receives the first information from the payload apparatus via the first communication link. In this embodiment, the information communicated between the UAV and the payload apparatus via the first communication link is collectively referred to as the first information. In practical applications, the information that the UAV communicates to the payload apparatus via the first communication link may be different from the information the UAV receives from the payload apparatus via the first communication link. For example, the first information communicated from the UAV to the payload apparatus via the first communication link may include a control command configured to control the payload apparatus. The first information received by the UAV from the payload apparatus via the first communication link may include alarm information.

The following describes an example in which the UAV communicates the first information to the payload apparatus via the first communication link. The remote-control device (for example, the control device 140 shown in FIG. 1) communicates the first information to the UAV. The remote-control device transmits the first information to the UAV via a communication link with the UAV (hereinafter referred to as a third communication link). The remote-control device may, for example, transmit the first information to the UAV according to a user's operation. After receiving the first information transmitted by the remote-control device via the third communication link, the UAV determines whether the first information indicates to be communicated with the payload apparatus. When the first information indicates to be communicated with the payload apparatus, the UAV communicates the first information with the payload apparatus via the first communication link. The first information may include, for example, a control command configured to control the payload apparatus. When the first information indicates to be transmitted to the UAV, the UAV sends the first information to the flight controller of the UAV. The first information includes a field for identifying a receiving end (i.e., a transmission destination) of the first information. If the field identifies that the receiving end of the first information is a UAV, it means that the first information indicates to be transmitted to the UAV. If the field identifies that the receiving end of the first information is a payload apparatus, it indicates that the first information indicates to be transmitted to the payload apparatus. Therefore, in this embodiment, the remote-control device can implement the control of the payload apparatus.

The following describes an example in which the UAV receives the first information from the payload apparatus via the first communication link. The payload apparatus transmits the first information to the UAV. The UAV receives the first information transmitted by the payload apparatus via the first communication link, and then the UAV transmits the first information received from the payload apparatus to the remote-control device. The UAV may transmit the first information to the remote-control device via the communication link with the remote-control device (hereinafter referred to as the third communication link). Optionally, the first information received by the UAV from the payload apparatus via the first communication link may include alarm information. For example, the alarm information may be an alarm information that the temperature of the payload apparatus is too high. After receiving the alarm information via the third communication link, the remote-control device may, for example, output the alarm information via an output device, such as displaying the alarm information via a display device.

In some embodiments, transmitting the second information between the UAV and the payload apparatus via the second communication link includes: receiving the second information by the UAV from the payload apparatus via the second communication link. In this embodiment, the payload apparatus transmits the second information to the UAV. The second information may include sensor data, e.g., image data, environmental detection parameters, etc. The UAV receives the second information transmitted by the load via the second communication link, and then transmits the second information to the remote-control device. The UAV can send the second information via a communication link with the remote-control device (referred to as a fourth communication link). After receiving the second information via the fourth communication link, the remote-control device may, for example, output the second information via an output device, such as displaying the second information via the display device.

In some embodiments, the UAV and the remote-control device can communicate wirelessly. Therefore, before the UAV communicates with the remote-control device, the UAV may establish a communication link with the remote-control device via an antenna. The UAV may be connected to the remote-control device via a first antenna to establish the third communication link, and may also be connected to the remote-control device via a second antenna to establish the fourth communication link.

In some embodiments, the third communication link and the fourth communication link may be the same communication link. In this case, the above-mentioned first antenna and the second antenna are the same antenna; that is, the UAV is connected to the remote-control device via the antenna to establish the communication link, and the antenna has a transceiver function.

In some embodiments, the third communication link and the fourth communication link may be different communication links. Correspondingly, the aforementioned first antenna and second antenna are different antennas. Optionally, security of the third communication link may be higher than security of the fourth communication link, and a bandwidth of the third communication link may be lower than a bandwidth of the fourth communication link. The third communication link corresponds to the first communication link; the UAV transmits the information received from the first communication link to the remote-control device via the third communication link, and the UAV transmits the information received from the third communication link to the payload apparatus via the first communication link. The fourth communication link corresponds to the second communication link, and the UAV transmits the information received from the second communication link to the remote-control device via the fourth communication link.

In some embodiments, the third communication link may be a command channel (e.g., a channel assigned to transmit commands and/or non-image data), and the fourth communication link may be an image transmission channel (e.g., a channel assigned to transmit image data, environmental data, sensor data, and/or non-command data).

In some embodiments, the first communication link may be a command channel, and the second communication link may be an image transmission channel.

In some embodiments, since the UAV and the payload apparatus communicate information via two communication links, the UAV can be connected to the payload apparatus via two communication interfaces, and the two communication interfaces may be a first communication interface and a second communication interface.

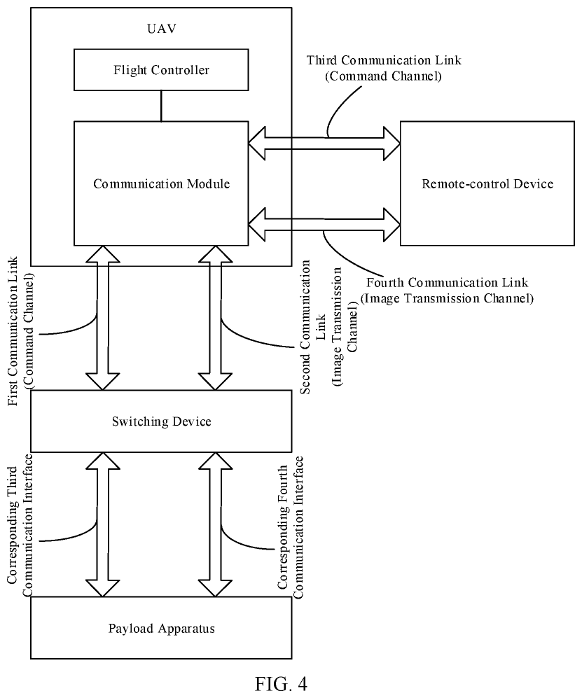

In some embodiments, the UAV and the payload apparatus can be directly connected. For example, as shown in FIG. 3, the UAV can identify communication protocol of the payload apparatus, and the payload apparatus can also identify the communication protocol of the UAV. In this embodiment, before the UAV communicates with the payload apparatus, the UAV may be connected to the payload apparatus via the first communication interface to establish the first communication link, and the UAV may also be connected to the payload apparatus via the second communication interface to establish the second communication link.

In some embodiments, the UAV and the payload apparatus need to be connected via an adaptor device, for example, as shown in FIG. 4. That is, the adaptor device is connected between the UAV and the payload apparatus, and the payload apparatus cannot recognize the communication protocol of the UAV, but the adaptor device can identify the communication protocol of the payload apparatus and the communication protocol of the UAV. In this embodiment, before communicating with the payload apparatus, the UAV can be connected to the adaptor device via the first communication interface to establish the first communication link and can be connected to the transfer device via the second communication interface to establish the second communication link. In addition, the adaptor device may include a third communication interface and a fourth communication interface. The adaptor device may be connected to the payload apparatus via the third communication interface, and the adaptor device may be further connected to the payload apparatus via the fourth communication interface. The third communication interface and the fourth communication interface may not be the same interface. As such, two communication links can also be established between the adaptor device and the payload apparatus, one communication link corresponds to the third communication interface, and the other communication link corresponds to the fourth communication interface.

In the process of information transmission, the UAV transmits the first information to the adaptor device via the first communication link; the adaptor device then transmits the first information received via the first communication link to the payload apparatus via the third communication interface. The payload apparatus can transmit the first information to the adaptor device via a communication link corresponding to the third communication interface. After receiving the first information via the third communication interface, the adaptor device may forward the first information to the UAV via the first communication link. The payload apparatus may also transmit the second information to the adaptor device via a communication link corresponding to the fourth communication interface. After receiving the second information via the fourth communication interface, the adaptor device may forward the second information to the UAV via the second communication link.

It should be noted that FIG. 3 and FIG. 4 are shown as examples in which the communication module of the UAV communicates with the payload apparatus and the remote-control device, respectively.

In some embodiments, if the communication protocol of the payload apparatus is the first communication protocol, the communication protocol of the UAV can be the second communication protocol, and the first communication protocol is different from the second communication protocol.

The adaptor device can receive the first information based on the first communication protocol that is transmitted by the payload apparatus via the third communication interface, and then convert the first information based on the first communication protocol into a first information based on the second communication protocol, and then transmits the first information based on the second communication protocol to the UAV via the first communication link.

The adaptor device can receive the first information based on the second communication protocol that is transmitted by the UAV via the second communication link, and then convert the first information based on the second communication protocol into the first information based on the first communication protocol, and then transmits the first information based on the first communication protocol to the payload apparatus via the third communication interface.

The adaptor device can receive a second information based on the first communication protocol that is transmitted by the payload apparatus via the fourth communication interface, and then convert the second information based on the first communication protocol into a second information based on the second communication protocol, and then transmits the second information based on the second communication protocol to the UAV via the second communication link.

In some embodiments, the aforementioned third communication interface may be a controller area network (CAN) interface, or a universal asynchronous receiver/transmitter (UART) interface, or a recommended standard (RS)-232 interface, or RS-485 interface, or RS-422 interface, which is not limited by the embodiment. The aforementioned fourth communication interface may be a network port, and the embodiment is not limited to this.

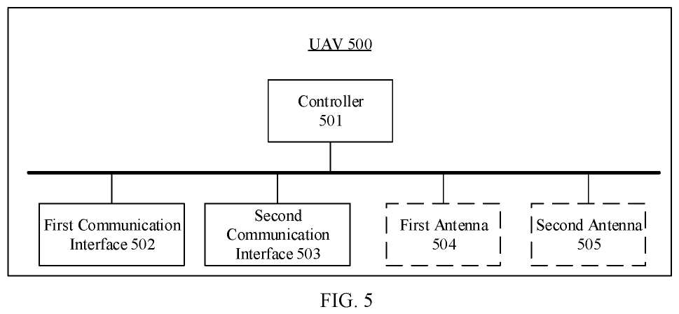

FIG. 5 is a schematic structural diagram of a UAV according to an embodiment of the present disclosure. As shown in FIG. 5, the UAV 500 of this embodiment may include: a controller 501, a first communication interface 502, and a second communication interface 503; The controller 501, the first communication interface 502, and the second communication interface 503 may be communicatively connected.

The first communication interface 502 is configured to establish a first communication link.

The second communication interface 503 is configured to establish a second communication link.

The controller 501 is configured to control the first communication interface 502 to communicate a first information with the payload apparatus via the first communication link; and to control the second communication interface 503 to communicate a second information with the payload apparatus via the second communication link.

Security of the first communication link may be higher than security of the second communication link, and a bandwidth of the first communication link may be lower than a bandwidth of the second communication link.

In some embodiments, the UAV of this embodiment may further include a first antenna 504. The first antenna 504 is configured to establish a third communication link with the remote-control device.

Optionally, the controller 501 is further configured to control the first antenna 504 to receive the first information from the remote-control device via the third communication link before controlling the first communication interface 502 to communicate the first information to the payload apparatus via the first communication link. When the controller 501 controls the first communication interface 502 to communicate the first information to the payload apparatus via the first communication link, it is specifically configured to: when the first information indicates to be transmitted to the payload apparatus, control the first communication interface 502 to transmit the first information to the payload apparatus via the first communication link. Optionally, the first information includes a control command configured to control the payload apparatus.

Optionally, when the controller 501 controls the first communication interface 502 to communicate the first information to the payload apparatus via the first communication link, it is specifically configured to: control the first communication interface 502 to receive the first information from the payload apparatus via the communication link. The controller 501 is further configured to: after controlling the first communication interface 502 to communicate the first information to the payload apparatus via the first communication link, control the first antenna 504 to transmit the first information to the remote-control device via the third communication link. Optionally, the first information includes alarm information.

Optionally, the UAV of this embodiment may further include a second antenna 505.

The second antenna 505 is configured to establish a fourth communication link with the remote-control device.

When the controller 501 controls the second communication interface 503 to communicate the second information to the payload apparatus via the second communication link, it is specifically configured to: control the second communication interface 503 to receive the second information from the payload apparatus via the second communication link. The controller 501 is further configured to control the second antenna 505 to transmit the second information to the remote-control device via the fourth communication link after controlling the second communication interface 503 to communicate the second information to the payload apparatus via the second communication link.

Optionally, the second information may include sensor data.

In some embodiments, the first communication link may be a command channel.

In some embodiments, the second communication link may be an image transmission channel.

In some embodiments, the third communication link may be a command channel.

In some embodiments, the fourth communication link may be an image transmission channel.

In some embodiments, the first communication interface 502 may be configured to be connected to payload apparatus to establish the first communication link.

The second communication interface 503 may be configured to be connected to the payload apparatus to establish the second communication link. The first communication interface 502 is different from the second communication interface 503.

In some embodiments, the first communication interface 502 may be configured to be connected to a adaptor device to establish the first communication link.

The second communication interface 503 may be configured to be connected to the adaptor device to establish the second communication link. The adaptor device may include a third communication interface and a fourth communication interface, and the third communication interface and the fourth communication interface are respectively connected to the payload apparatus. The third communication interface may be configured to forward the first information. The fourth communication interface may be configured to forward the second information.

Optionally, the third communication interface may be a CAN interface, a UART interface, an RS-232 interface, an RS-485 interface, or an RS-422 interface. The fourth communication interface may be a network port.

The UAV of this embodiment can be used to implement the technical solution of the UAV in any of the foregoing method embodiments, and its implementation principles and technical effects are similar, and will not be repeated here.

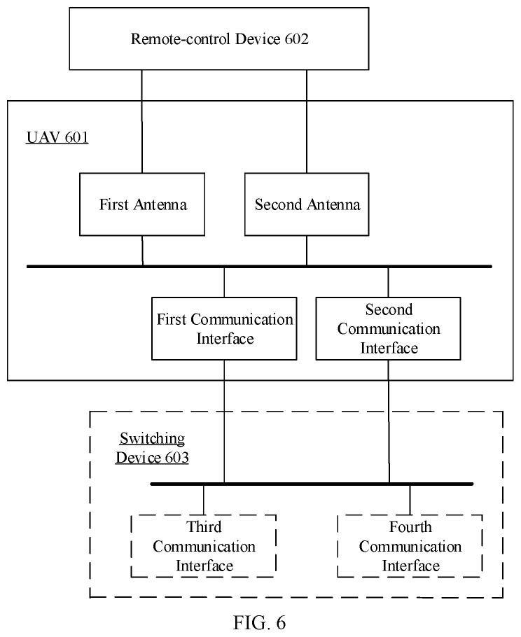

FIG. 6 is a schematic structural diagram of a communication control system for a UAV according to an embodiment of the present disclosure. As shown in FIG. 6, the communication control system for a UAV in this embodiment may include: a UAV 601 and a remote-control device 602.

The UAV 601 is configured to: receive a first information from the remote-control device 602; and when the first information indicates to be transmitted to a payload apparatus, transmit the first information to the payload apparatus via a first communication link; and/or, receive the first information from the payload apparatus via the first communication link, and transmit the first information to the remote-control device 602; and receive a second information from the payload apparatus via a second communication link, and transmit the second information to the remote-control device 602.

The remote-control device 602 is configured to: transmit the first information to and/or receive the first information from the UAV 601; and receive the second information from the UAV 601.

Security of the first communication link may be higher than security of the second communication link, and a bandwidth of the first communication link may be lower than a bandwidth of the second communication link.

In some embodiments, the UAV 601 is configured to: receive the first information from the remote-control device 602 via the third communication link; and/or, to transmit the first information to the remote-control device 602 via a third communication link; and transmit the second information to the remote-control device 602 via a fourth communication link.

Security of the third communication link may be higher than security of the fourth communication link, and a bandwidth of the third communication link may be lower than a bandwidth of the fourth communication link.

In some embodiments, the first information received by the UAV from the remote-control device may include a control command configured to control the payload apparatus. The first information received by the UAV from the payload apparatus may include alarm information.

In some embodiments, the second information may include sensor data.

In some embodiments, the first communication link may be a command channel.

In some embodiments, the second communication link may be an image transmission channel.

In some embodiments, the third communication link may be a command channel.

In some embodiments, the fourth communication link may be an image transmission channel.

In some embodiments, the UAV 601 is configured to be connected to the payload apparatus via a first communication interface to establish the first communication link; and to connect to the payload apparatus via a second communication interface to establish the second communication link.

The first communication interface is different from the second communication interface.

In some embodiments, the communication control system for a UAV of this embodiment may further include a adaptor device 603.

The UAV 601 is further configured to be connected to the adaptor device 603 via the first communication interface to establish the first communication link and be connected to the adaptor device 603 via the second communication interface to establish the second communication link.

The adaptor device 603 may include a third communication interface and a fourth communication interface, and the third communication interface and the fourth communication interface are respectively connected to the payload apparatus.

The adaptor device may be configured to forward the first information via the third communication interface and forward the second information via the fourth communication interface.

In some embodiments, the third communication interface may be a CAN interface, a UART interface, an RS-232 interface, an RS485 interface, or an RS422 interface. The fourth communication interface may be a network port.

In some embodiments, the UAV 601 is also configured to connect to the remote-control device 602 via a first antenna to establish the third communication link and connect to the remote-control device 602 via a second antenna to establish the fourth communication link.

The UAV 601 can implement the structure of the device embodiment shown in FIG. 5, and the system of this embodiment can be the technical solution of any of the above-mentioned embodiments, and its implementation principles and technical effects are similar, and will not be repeated here.

Those of ordinary skill in the art can understand that all or part of the steps in the above method embodiments can be implemented by a program that instructs relevant hardware. The foregoing program can be stored in a computer-readable storage medium, and when the program is executed, the steps of the foregoing method embodiment may be performed. The foregoing storage medium may include read-only memory (ROM), random-access memory (RAM), magnetic disks or optical disks, and other mediums that can store program codes.

It should be noted that the above embodiments are only used to illustrate the technical solutions of the present disclosure, but not to limit it. Although the present disclosure has been described in detail with reference to the foregoing embodiments, those of ordinary skill in the art should understand that the technical solutions recorded in the foregoing embodiments can still be modified, or some or all of the technical features can be equivalently replaced. The modifications or replacements do not make the essence of the corresponding technical solutions deviate from the scope of the technical solutions of the embodiments of the present disclosure.

What is claimed is:

1. A communication control method for an unmanned aerial vehicle (UAV), comprising:
transmitting a first information between the UAV and a payload apparatus via a first communication link; and
transmitting a second information between the UAV and the payload apparatus via a second communication link; wherein:
security of the first communication link is higher than security of the second communication link, and a bandwidth of the first communication link is lower than a bandwidth of the second communication link.

2. The method according to claim 1, further comprising:
before transmitting the first information between the UAV and the payload apparatus via the first communication link:
receiving the first information by the UAV from a remote-control device via a third communication link; wherein:
transmitting the first information between the UAV and the payload apparatus via the first communication link comprises:
in response to the first information indicating a transmission destination being the payload apparatus, transmitting the first information by the UAV to the payload apparatus via the first communication link.

3. The method according to claim 2, wherein the first information comprises a control command configured to control the payload apparatus.

4. The method according to claim 1, wherein:
transmitting the first information between the UAV and the payload apparatus via the first communication link comprises:
receiving the first information by the UAV from the payload apparatus via the first communication link; and
the method further comprises:
after the UAV receives the first information from the payload apparatus via the first communication link, transmitting the first information by the UAV to a remote-control device via a third communication link.

5. The method according to claim 4, wherein the first information comprises alarm information.

6. The method according to claim 2, further comprising:
connecting the UAV to the remote-control device via a first antenna to establish the third communication link.

7. The method according to claim 2, wherein the third communication link is a command channel.

8. The method according to claim 1, wherein:
transmitting the second information between the UAV and the payload apparatus via the second communication link comprises:
receiving the second information by the UAV from the payload apparatus via the second communication link; and
the method further comprises:
after the UAV receives the second information from the payload apparatus via the second communication link, transmitting the second information by the UAV to a remote-control device via a fourth communication link.

9. The method according to claim 8, wherein the second information comprises sensor data.

10. The method according to claim 8, further comprising:
connecting the UAV to the remote-control device via a second antenna to establish a fourth communication link.

11. The method according to claim 10, wherein the fourth communication link is the image transmission channel.

12. The method according to claim 1, wherein the first communication link is a command channel.

13. The method according to claim 1, wherein the second communication link is an image transmission channel.

14. The method according to claim 1, further comprising:
connecting the UAV to the payload apparatus via a first communication interface to establish the first communication link; and
connecting the UAV to the payload apparatus via a second communication interface to establish the second communication link; wherein:
the first communication interface is different from the second communication interface.

15. The method according to claim 1, further comprising:
connecting the UAV to an adaptor device via a first communication interface to establish the first communication link; and
connecting the UAV to the adaptor device via a second communication interface to establish the second communication link; wherein:
the adaptor device comprises a third communication interface and a fourth communication interface, the third communication interface and the fourth communication interface being respectively connected to the payload apparatus; and
transmitting the first information between the UAV and the payload apparatus via the first communication link comprises:
transmitting the first information between the UAV and the payload apparatus via the first communication link and the third communication interface of the adaptor device; and
transmitting the second information between the UAV and the payload apparatus via the second communication link comprises:
transmitting the second information between the UAV and the payload apparatus via the second communication link and the fourth communication interface of the adaptor device.

16. The method according to claim 15, wherein:
the third communication interface is one of: a controller area network (CAN) interface, a universal asynchronous receiver/transmitter (UART) interface, a recommended standard (RS)-232 interface, an RS-485 interface, or an RS-422 interface; and
the fourth communication interface is a network port.

17. An unmanned aerial vehicle (UAV), comprising:
a first communication interface configured to establish a first communication link;
a second communication interface configured to establish a second communication link; and
a controller configured to control the first communication interface to communicate a first information with a payload apparatus via the first communication link and control the second communication interface to communicate a second information with the payload apparatus via the second communication link; wherein:
security of the first communication link is higher than security of the second communication link, and a bandwidth of the first communication link is lower than a bandwidth of the second communication link.
